(19) United States
(12) Patent Application Publication
(10) Pub. No.: US 2026/0222646 A1
(43) Pub. Date: Jul. 30, 2026

(54) A DISPLAY DEVICE

(71) Applicant: LG ELECTRONICS INC., Seoul (KR)

(72) Inventor: Eun Young CHO, Seoul (KR)

(73) Assignee: LG ELECTRONICS INC., Seoul (KR)

(21) Appl. No.: 19/144,663

(22) PCT Filed: Jan. 13, 2023
(86) PCT No.: PCT/KR2023/000628

§ 371 Date: Jun. 30, 2025

(51) Int. Cl. H04N 21/436; H04W 48/02; H04W 48/16; H04W 48/18

(52) U.S. Cl. CPC H04N 21/436; H04W 48/02; H04W 48/16; H04W 48/18

(57) ABSTRACT

A display device according to an embodiment of the present invention may comprise: a case; a display supported by the case; a network interface accessing a wireless network; and a controller which changes an access network on the basis of the displacement of the display device or whether the case is open or closed.

### TECHNICAL FIELD

The present disclosure relates to a display device connected to a wireless network.

### BACKGROUND ART

TVs that can connect to networks via wired or wireless networks are becoming widespread. Accordingly, TVs can provide various services utilizing networks.

For example, TVs can receive and provide content data in real time via a wireless network. In addition, TVs can provide IoT (Internet of Things) functions that control electronic devices connected to the same wireless network as the network to which the TV is connected.

In the case of a movable TV, the communication quality may vary depending on the movement of the TV. For example, if a TV connected to an AP (Access Point) located in the living room moves to a room, the distance between the TV and the AP may increase. Accordingly, the wireless network connection status of the TV may become unstable, such as a decrease in the signal level of the wireless network.

Meanwhile, the TV may be connected to any one of multiple wireless networks.

For example, the TV may be connected to a 5G network or a 2.4G network. The 5G network may have a bandwidth of 5.180 to 5.850 GHz. 2.4G networks can have a bandwidth of 2.4 to 2.462 GHZ.

Since 5G networks have a higher bandwidth than 2.4G networks, data transmission and reception are possible at a faster speed than 2.4G networks. Accordingly, 5G networks can provide higher resolution content than 2.4G networks.

However, since 5G networks have a higher bandwidth than 2.4G networks, diffraction of communication signals may be difficult. Accordingly, if a TV connected to a 5G network moves and an obstacle such as a wall is located between the AP and the TV, the wireless network connection of the TV may become unstable. Therefore, if an obstacle is located between the AP and the TV, the network service can be stably provided by connecting to a 2.4G network that has better diffraction of communication signals than the 5G network.

Accordingly, users of mobile TVs can directly change the access network to a wireless network with a higher signal level when they move the TV. However, there may be inconvenience as the user has to change the access network every time he moves the TV.

### DISCLOSURE

### Technical Problem

An object of this present disclosure is to minimize inconvenience caused by unstable wireless network connection due to movement of the position of a movable display device.

### Technical Solution

A display device according to an embodiment of the present disclosure comprises a case; a display supported by the case; a network interface connected to a wireless network; and a controller configured to change an access network based on movement of a position of the display device or whether the case is opened or closed.

The display device according to an embodiment of the present disclosure can change an access network according to a preset priority when a signal level of a connected wireless network is lower than a preset reference level.

The display device according to an embodiment of the present disclosure can change the access network by acquiring another wireless network with a different bandwidth than a currently connected wireless network as a first priority.

The display device according to an embodiment of the present disclosure can change the access network by acquiring another wireless network with a connection history as a second priority and another wireless network with no connection history as a third priority.

The display device according to an embodiment of the present disclosure can change the access network by acquiring another wireless network in which password information is stored as a second priority and another wireless network in which password information is not stored as a third priority.

The display device according to an embodiment of the present disclosure can display a message recommending a wired network connection if a currently connected wireless network cannot be changed to another wireless network.

The display device according to an embodiment of the present disclosure can, when acquiring whether the access network has been changed or not, display a message notifying that an external device connected to the access network cannot be controlled if the access network is changed.

The display device according to an embodiment of the present disclosure can, after changing the access network, when receiving a user input for selecting an external device connected to a wireless network before the changing, display a message requesting a change of the wireless network connected to the external device.

The display device according to an embodiment of the present disclosure can, when receiving the user input, transmit a control signal to the external device to determine whether control is possible, and if the external device cannot be controlled, display the message requesting the change of the wireless network connected to the external device.

The display device according to an embodiment of the present disclosure can change the access network based on a user's preference or a signal level of another wireless network when a signal level of the access network is higher than a preset reference level.

### Advantageous Effects

According to an embodiment of the present disclosure, the access network of the display device can be automatically changed to minimize inconvenience to the user.

According to an embodiment of the present disclosure, even if a user does not directly change the access network, the display device can remain connected to the optimal wireless network.

### DESCRIPTION OF DRAWINGS

FIG. 1 is a block diagram illustrating a configuration of a display device according to an embodiment of the present disclosure.

FIG. 2 is a block diagram of a remote control device according to an embodiment of the present disclosure.

FIG. 3 shows an example of an actual configuration of a remote control device according to an embodiment of the present disclosure.

FIG. 4 shows an example of utilizing a remote control device according to an embodiment of the present disclosure.

FIG. 5 is an exemplary drawing showing a closed case of a display device according to an embodiment of the present disclosure.

FIG. 6 is an exemplary drawing showing an open case of a display device according to an embodiment of the present disclosure.

FIG. 7 is an exemplary drawing showing a display device and a remote control device according to an embodiment of the present disclosure.

FIG. 8 is a flowchart explaining a method for a display device according to an embodiment of the present disclosure to change an access network and an operation after changing the access network.

FIG. 9 is an example of wireless network information acquired by a display device located in a living room according to an embodiment of the present disclosure.

FIG. 10 is an example of wireless network information acquired by a display device located in a room according to an embodiment of the present disclosure.

FIG. 11 is an example diagram illustrating a message that requests a change of a wireless network to which an external device is connected, displayed by a display device according to an embodiment of the present disclosure.

FIG. 12 is an example diagram illustrating a message that requests a change of a wireless network to which an external device is connected, displayed by a display device according to an embodiment of the present disclosure.

FIG. 13 is a flowchart illustrating a method for a display device to change an access network according to an embodiment of the present disclosure.

FIG. 14 is an example of wireless network information acquired by a display device according to an embodiment of the present disclosure.

FIG. 15 is an example diagram illustrating a message displayed by a display device according to an embodiment of the present disclosure to obtain whether to change an access network to a wireless network having a first priority.

FIG. 16 is an example diagram illustrating a message displayed by a display device according to an embodiment of the present disclosure to obtain whether to change an access network to a wireless network having a second priority.

FIG. 17 is an example diagram illustrating a message displayed by a display device according to an embodiment of the present disclosure to obtain whether to change an access network to a wireless network having a third priority.

FIG. 18 an example diagram illustrating a message displayed on a display of a mobile terminal controlling a display device according to an embodiment of the present disclosure.

FIG. 19 is an example diagram illustrating a message displayed by a display device according to an embodiment of the present disclosure to recommend a wired network connection.

### BEST MODE

Hereinafter, embodiments of the present disclosure will be described in detail with reference to the drawings. The suffixes “module” and “unit” for components used in the following description are merely provided only for facilitation of preparing this specification, and thus they are not granted a specific meaning or function.

A display device according to an embodiment of the present disclosure is, for example, an intelligent display device in which a computer support function is added to a broadcast reception function, and may have an easy-to-use interface such as a handwritten input device, a touch screen, a spatial remote control, or the like since an Internet function is added while fulfilling the broadcast receiving function. In addition, it is connected to the Internet and a computer with the support of a wired or wireless Internet function, so that functions such as e-mail, web browsing, banking, or games can also be performed. A standardized general-purpose OS may be used for these various functions.

Accordingly, in the display device described in the present disclosure, various user-friendly functions can be performed because various applications can be freely added or deleted, for example, on a general-purpose OS kernel. More specifically, the display device may be, for example, a network TV, HBBTV, smart TV, LED TV, OLED TV, and the like, and may be applied to a smart phone in some cases.

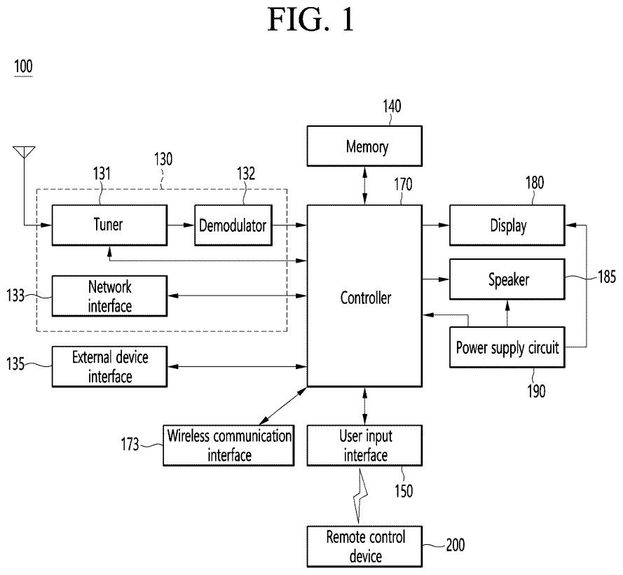

FIG. 1 is a block diagram showing a configuration of a display device according to an embodiment of the present disclosure.

Referring to FIG. 1, a display device 100 may include a broadcast receiver 130, an external device interface 135, a memory 140, a user input interface 150, a controller 170, a wireless communication interface 173, a display 180, a speaker 185, and a power supply circuit 190.

The broadcast receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The external device interface 135 may receive an application or a list of applications in an external device adjacent thereto, and transmit the same to the controller 170 or the memory 140.

The external device interface 135 may provide a connection path between the display device 100 and an external device. The external device interface 135 may receive one or more of images and audio output from an external device connected to the display device 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a component terminal.

The image signal of the external device input through the external device interface 135 may be output through the display 180. The audio signal of the external device input through the external device interface 135 may be output through the speaker 185.

The external device connectable to the external device interface 135 may be any one of a set-top box, a Blu-ray player, a DVD player, a game machine, a sound bar, a smartphone, a PC, a USB memory, and a home theater, but this is only an example.

The network interface 133 may provide an interface for connecting the display device 100 to a wired/wireless network including an Internet network. The network interface 133 may transmit or receive data to or from other users or other electronic devices through a connected network or another network linked to the connected network.

In addition, a part of content data stored in the display device 100 may be transmitted to a selected user among a selected user or a selected electronic device among other users or other electronic devices registered in advance in the display device 100.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a contents provider or a network operator. That is, the network interface 133 may receive content such as movies, advertisements, games, VOD, and broadcast signals and information related thereto provided from a contents provider or a network provider through a network.

In addition, the network interface 133 may receive update information and update files of firmware provided by the network operator, and may transmit data to an Internet or contents provider or a network operator.

The network interface 133 may select and receive a desired application from among applications that are open to the public through a network.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 100 may play a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication interface 173 may detect (or recognize) a wearable device capable of communication around the display device 100.

Furthermore, when the detected wearable device is an authenticated device to communicate with the display device 100 according to the present disclosure, the controller 170 may transmit at least a portion of data processed by the display device 100 to the wearable device through the wireless communication interface 173. Therefore, a user of the wearable device may use data processed by the display device 100 through the wearable device.

The display 180 can generate a driving signal by converting a video signal, data signal, OSD signal processed by the controller 170 or a video signal, data signal, etc. received from the external device interface 135 into R, G, and B signals, respectively.

Meanwhile, since the display device 100 illustrated in FIG. 1 is only an embodiment of the present disclosure, some of the illustrated components may be integrated, added, or omitted depending on the specifications of the display device 100 actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play the same.

For example, the display device 100 may be divided into an image processing device, such as a set-top box, for receiving broadcast signals or content according to various network services, and a content playback device that plays content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 and the speaker 185.

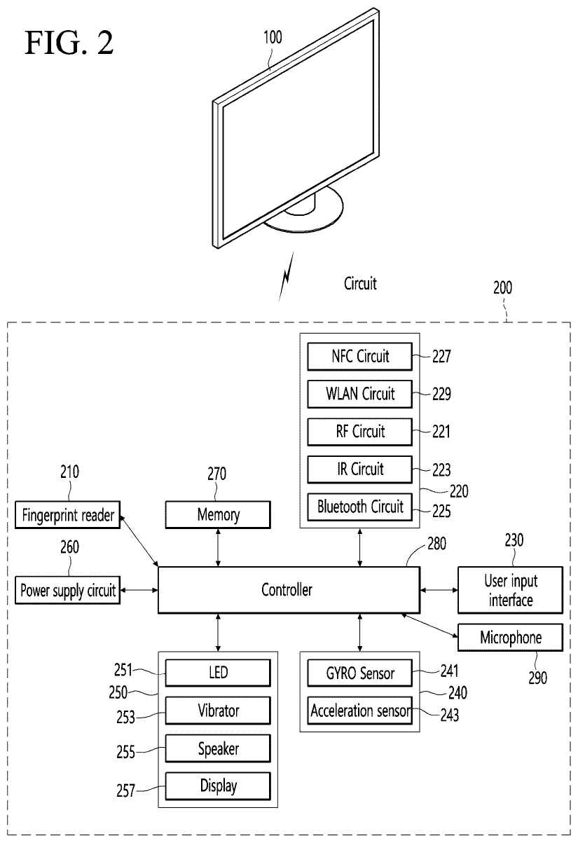

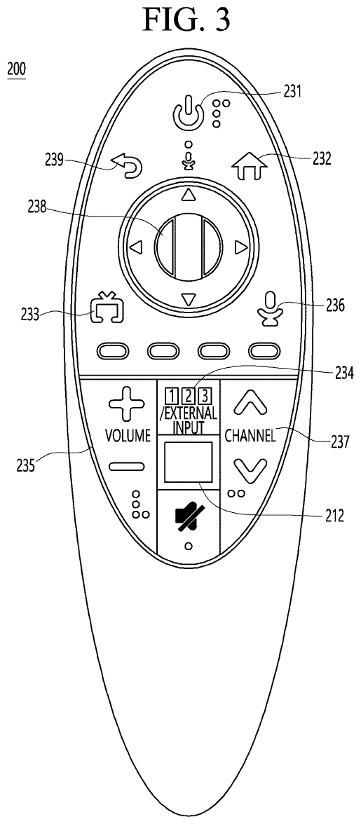

Next, a remote control device according to an embodiment of the present disclosure will be described with reference to FIGS. 2 to 3.

FIG. 2 is a block diagram of a remote control device according to an embodiment of the present disclosure, and FIG. 3 shows an actual configuration example of a remote control device 200 according to an embodiment of the present disclosure.

First, referring to FIG. 2, the remote control device 200 may include a fingerprint reader 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 may transmit and receive signals to and from any one of display devices according to embodiments of the present disclosure described above.

The remote control device 200 may include an RF circuit 221 capable of transmitting and receiving signals to and from the display device 100 according to the RF communication standard, and an IR circuit 223 capable of transmitting and receiving signals to and from the display device 100 according to the IR communication standard. In addition, the remote control device 200 may include a Bluetooth circuit 225 capable of transmitting and receiving signals to and from the display device 100 according to the Bluetooth communication standard. In addition, the remote control device 200 may include an NFC circuit 227 capable of transmitting and receiving signals to and from the display device 100 according to the NFC (near field communication) communication standard, and a WLAN circuit 229 capable of transmitting and receiving signals to and from the display device 100 according to the wireless LAN (WLAN) communication standard.

In addition, the remote control device 200 may transmit a signal containing information on the movement of the remote control device 200 to the display device 100 through the wireless communication circuit 220.

In addition, the remote control device 200 may receive a signal transmitted by the display device 100 through the RF circuit 221, and transmit a command regarding power on/off, channel change, volume adjustment, or the like to the display device 100 through the IR circuit 223 as necessary.

The user input interface 230 may include a keypad, a button, a touch pad, a touch screen, or the like. The user may input a command related to the display device 100 to the remote control device 200 by operating the user input interface 230. When the user input interface 230 includes a hard key button, the user may input a command related to the display device 100 to the remote control device 200 through a push operation of the hard key button. Details will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back-play button 239.

The fingerprint recognition button 212 may be a button for recognizing a user's fingerprint. In one embodiment, the fingerprint recognition button 212 may enable a push operation, and thus may receive a push operation and a fingerprint recognition operation.

The power button 231 may be a button for turning on/off the power of the display device 100.

The home button 232 may be a button for moving to the home screen of the display device 100.

The live button 233 may be a button for displaying a real-time broadcast program.

The external input button 234 may be a button for receiving an external input connected to the display device 100.

The volume control button 235 may be a button for adjusting the level of the volume output by the display device 100.

The voice recognition button 236 may be a button for receiving a user's voice and recognizing the received voice.

The channel change button 237 may be a button for receiving a broadcast signal of a specific broadcast channel.

The OK button 238 may be a button for selecting a specific function, and the back-play button 239 may be a button for returning to a previous screen.

A description will be given referring again to FIG. 2.

When the user input interface 230 includes a touch screen, the user may input a command related to the display device 100 to the remote control device 200 by touching a soft key of the touch screen. In addition, the user input interface 230 may include various types of input means that may be operated by a user, such as a scroll key or a jog key, and the present embodiment does not limit the scope of the present disclosure.

The sensor 240 may include a gyro sensor 241 or an acceleration sensor 243, and the gyro sensor 241 may sense information regarding the movement of the remote control device 200.

For example, the gyro sensor 241 may sense information about the operation of the remote control device 200 based on the x, y, and z axes, and the acceleration sensor 243 may sense information about the moving speed of the remote control device 200. Meanwhile, the remote control device 200 may further include a distance measuring sensor to sense the distance between the display device 100 and the display 180.

The output interface 250 may output an image or audio signal corresponding to the operation of the user input interface 230 or a signal transmitted from the display device 100.

The user may recognize whether the user input interface 230 is operated or whether the display device 100 is controlled through the output interface 250.

For example, the output interface 450 may include an LED 251 that emits light, a vibrator 253 that generates vibration, a speaker 255 that outputs sound, or a display 257 that outputs an image when the user input interface 230 is operated or a signal is transmitted and received to and from the display device 100 through the wireless communication interface 225.

In addition, the power supply circuit 260 may supply power to the remote control device 200, and stop power supply when the remote control device 200 has not moved for a predetermined time to reduce power consumption.

The power supply circuit 260 may restart power supply when a predetermined key provided in the remote control device 200 is operated.

The memory 270 may store various types of programs and application data required for control or operation of the remote control device 200.

When the remote control device 200 transmits and receives signals wirelessly through the display device 100 and the RF circuit 221, the remote control device 200 and the display device 100 transmit and receive signals through a predetermined frequency band.

The controller 280 of the remote control device 200 may store and refer to information on a frequency band capable of wirelessly transmitting and receiving signals to and from the display device 100 paired with the remote control device 200 in the memory 270.

The controller 280 may control all matters related to the control of the remote control device 200. The controller 280 may transmit a signal corresponding to a predetermined key operation of the user input interface 235 or a signal corresponding to the movement of the remote control device 200 sensed by the sensor 240 through the wireless communication interface 225.

Also, the microphone 290 of the remote control device 200 may obtain a speech.

A plurality of microphones 290 may be provided.

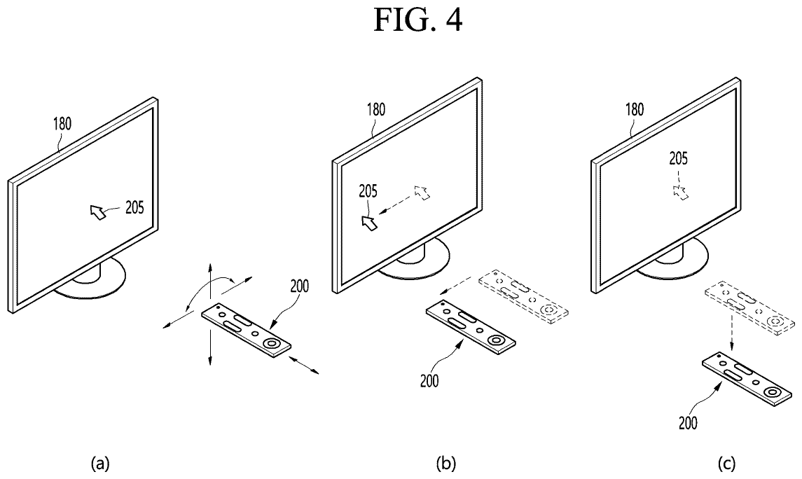

Next, a description will be given referring to FIG. 4.

FIG. 4 shows an example of using a remote control device according to an embodiment of the present disclosure.

In FIG. 4, (a) illustrates that a pointer 205 corresponding to the remote control device 200 is displayed on the display 180.

The user may move or rotate the remote control device 200 up, down, left and right. The pointer 205 displayed on the display 180 of the display device 100 may correspond to the movement of the remote control device 200. As shown in the drawings, the pointer 205 is moved and displayed according to movement of the remote control device 200 in a 3D space, so the remote control device 200 may be called a space remote control device.

In (b) of FIG. 4, it is illustrated that that when the user moves the remote control device 200 to the left, the pointer 205 displayed on the display 180 of the display device 100 moves to the left correspondingly.

Information on the movement of the remote control device 200 detected through a sensor of the remote control device 200 is transmitted to the display device 100. The display device 100 may calculate the coordinates of the pointer 205 based on information on the movement of the remote control device 200. The display device 100 may display the pointer 205 to correspond to the calculated coordinates.

In (c) of FIG. 4, it is illustrated that a user moves the remote control device 200 away from the display 180 while pressing a specific button in the remote control device 200. Accordingly, a selected area in the display 180 corresponding to the pointer 205 may be zoomed in and displayed enlarged.

Conversely, when the user moves the remote control device 200 to be close to the display 180, the selected area in the display 180 corresponding to the pointer 205 may be zoomed out and displayed reduced.

On the other hand, when the remote control device 200 moves away from the display 180, the selected area may be zoomed out, and when the remote control device 200 moves to be close to the display 180, the selected area may be zoomed in.

Also, in a state in which a specific button in the remote control device 200 is being pressed, recognition of up, down, left, or right movements may be excluded. That is, when the remote control device 200 moves away from or close to the display 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

Meanwhile, in the present specification, a pointer refers to an object displayed on the display 180 in response to an operation of the remote control device 200. Accordingly, objects of various shapes other than the arrow shape shown in the drawings are possible as the pointer 205. For example, the object may be a concept including a dot, a cursor, a prompt, a thick outline, and the like. In addition, the pointer 205 may be displayed corresponding to any one point among points on a horizontal axis and a vertical axis on the display 180, and may also be displayed corresponding to a plurality of points such as a line and a surface.

The display device 100 according to the embodiment of the present disclosure may be implemented in a movable form. That is, the display device 100 according to the embodiment of the present disclosure may be implemented as a portable display device that can be carried. For example, the display device 100 may further include a case that protects internal components and configurations including the display 180, and may be implemented so that the image is played back in an open state of the case and the movement is possible in a closed state of the case.

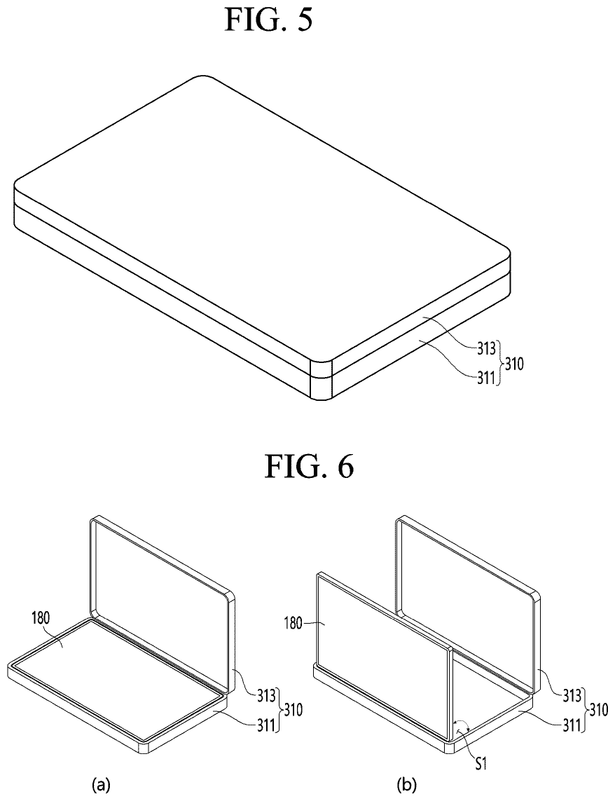

Next, the movable display device 100 according to the embodiment of the present disclosure is described with reference to FIGS. 5 to 7.

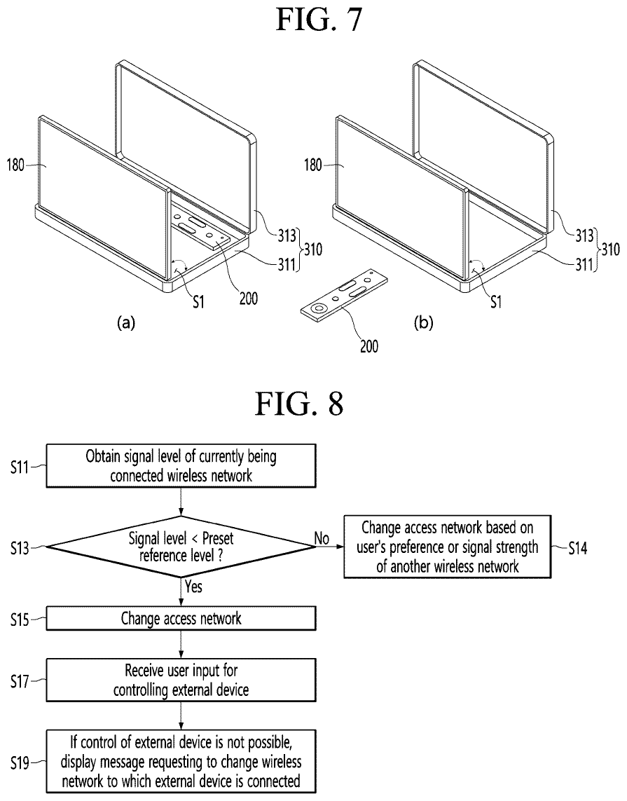

FIG. 5 is an exemplary drawing showing a closed state of a case of a display device according to an embodiment of the present disclosure, FIG. 6 is an exemplary drawing showing an open state of a case of a display device according to an embodiment of the present disclosure, and FIG. 7 is an exemplary drawing showing a display device and a remote control device according to an embodiment of the present disclosure.

As illustrated in the example of FIG. 5, the display device 100 according to the embodiment of the present disclosure may further include a case 310.

Various configurations of the display device 100 including the display 180 may be provided in the accommodation space formed by the case 310 and the interior of the case 310.

The case 310 may include a main body 311 and a cover 313 covering the main body 311.

The accommodation space formed by the case 310 may mean the space between the main body 311 and the cover 313. The display 180, the remote control device 200, etc. may be placed in the accommodation space formed by the case 310.

The interior of the case 310 may mean the interior of the main body 311 and the interior of the cover 313. That is, the interior of case 310 may mean the interior space of the main body 311 and the cover 31 that are not visible to the user. A main mode (not shown) equipped with the controller 170, etc. may be accommodated inside the case 310.

FIG. 5 may show a closed state of the case 310. If the case 310 is closed, the display 180, etc. may not be visible from the outside.

FIG. 6 may show the case 310 in an open state.

The cover 313 may be connected to the main body 311 via a hinge (not shown), etc.

The display 180 may be supported by the main body 311. The display 180 may be connected and fixed to the main body 311. The display 180 may be tilted at an angle while supported by the main body 311. For example, the display 180 may be connected to the main body 311 via a hinge (not shown), etc. and may be tilted at various angles. The display 180 may be tilted at various angles based on the point where it is connected to the main body 311. As illustrated in (a) of FIG. 6, the display 180 can be tilted to form 0 degrees with respect to the main body 311, and in this case, the display 180 can be completely accommodated in the accommodation space formed by the case 310. That is, when the display 180 is tilted to form 0 degrees with respect to the main body 311, the case 310 can be closed. Alternatively, as illustrated in (b) of FIG. 6, the display 180 can be tilted to form a right angle (90 degrees) with respect to the main body 311. Of course, the present invention is not limited to the example of FIG. 6, and the display 180 can be formed to be tilted within a range of 0 degrees to 180 degrees with respect to the main body 311. In addition, the display 180 can be formed to be able to be tilted more than 180 degrees with respect to the main body 311.

And, when the display 180 forms a 0 degree angle with the main body 311, a storage space S1 can be formed between the display 180 and the main body 311. The storage space S1 can be a space where a remote control device 200, a headset (not shown), etc. can be stored. Meanwhile, the name of the storage space is simply named for convenience of explanation, so it is reasonable that it is not limited thereto.

(a) of FIG. 7 shows a state where a remote control device 200 is stored in the storage space S1, and (b) of FIG. 7 shows a state where a remote control device 200 taken out from the storage space S1 is used.

As shown in FIG. 7, the remote control device 200 can be stored in the storage space S1. The user can open the case 310, tilt the display 180, and then take out the remote control device 200 housed in the storage space S1.

The display device 100 can wirelessly connect to the network through an AP (Access Point). The AP may be a device that generates a wireless network signal so that an electronic device can wirelessly connect to the network.

In the case of the display device 100 implemented in a mobile form, the wireless network environment may change depending on the movement of the display device 100. For example, if a TV connected to the AP (Access Point) located in the living room moves to a room, the distance between the TV and the AP (Access Point) may increase, causing the signal level to decrease. Alternatively, interference may occur in the transmission and reception of communication signals due to obstacles such as a door or wall between the AP and the TV. Accordingly, the wireless network communication quality of the TV may deteriorate, causing content interruption, etc.

Accordingly, a user of a mobile TV can directly change the access network to a wireless network with a higher signal level when moving the TV. However, there may be inconvenience in that the user has to change the access network directly every time the TV is moved.

Accordingly, the display device 100 according to one embodiment of the present disclosure is intended to automatically connect to the optimal wireless network according to movement of location, etc.

FIG. 8 is a flowchart for explaining a method for changing an access network and an operation after changing the access network by a display device according to an embodiment of the present.

The controller 170 can obtain a signal level of a wireless network being connected S11.

The controller 170 can obtain a signal level of a wireless network being connected in real time.

The signal level of the wireless network can be included in network information. The higher the signal level of the wireless network, the faster the communication speed can be.

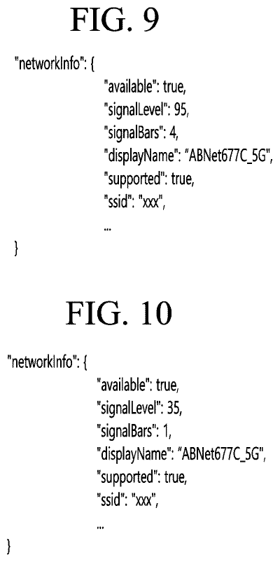

Referring to FIGS. 9 and 10, the signal level of the wireless network acquired by the controller 170 is described.

FIG. 9 is an example of wireless network information acquired by a display device located in a living room according to an embodiment of the present disclosure.

FIG. 9 may be the network information acquired by the controller 170 of the display device 100 located in the living room.

Referring to FIG. 9, the name of the network to which the display device 100 is connected is ‘ABNet677C_5G’. In addition, the signal level (signalLevel) of the network to which the display device 100 is connected is 95.

FIG. 10 is an example of wireless network information acquired by a display device located in a room according to an embodiment of the present disclosure.

FIG. 10 may be the network information acquired by a controller 170 of a display device 100 located in a room.

Referring to FIG. 10, the name of the network to which the display device 100 is connected is ‘ABNet677C_5G’. Accordingly, it can be seen that the network to which the display device 100 located in the room is connected is the same as the network to which the display device 100 located in the living room of FIG. 9 is connected.

In addition, the signal level (signalLevel) of the network to which the display device 100 is connected is 35. Accordingly, it can be seen that the network signal level received by the display device 100 located in the room is 60 lower than the network signal level received by the display device 100 located in the living room of FIG. 9.

That is, the network signal level acquired by the controller 170 may vary depending on the movement of display device 100, etc.

Again, FIG. 8 is described.

The controller 170 can obtain whether the signal level of the connected wireless network is lower than the preset reference level S13.

The controller 170 can obtain whether the signal level of the wireless network is lower than the preset reference level based on the movement of the position of the display device 100.

The preset reference level can be set to a level that prevents interruption of content provided in real time, but is not limited thereto.

For example, the preset reference level can be set in various ways depending on the performance of the AP (Access Point), the type of content provided by the display device 100, etc.

According to one embodiment, the controller 170 may obtain in real time whether the signal level of the connected wireless network is lower than the preset reference level. For example, the controller 170 may obtain in real time whether the signal level of the connected wireless network is lower than the preset reference level regardless of whether the position of the display device 100 is moved or not or whether the case 310 is opened or closed. The controller 170 may obtain whether the signal level of the connected wireless network is lower than the preset reference level at preset periods.

According to another embodiment, the controller 170 may obtain whether the signal level of the connected wireless network is lower than the preset reference level when the movement of the display device 100 is detected.

To this end, the controller 170 may detect the movement of the display device 100. There may be various methods for the controller 170 to detect the movement of the display device 100.

As a first example, the display device 100 may include various sensors for detecting the movement of the display device 100.

For example, the display device 100 may include an acceleration sensor or a gyro sensor. The gyro sensor 241 may sense information about the movement of the display device 100.

For example, the gyro sensor 241 can sense information about the operation of the display device 100 based on the x, y, and z axes, and the acceleration sensor 243 can sense information about the movement speed of the display device 100.

As a second example, the controller 170 can obtain whether the display device 100 is moving based on an image captured by a camera.

As a third example, the controller 170 can obtain whether the display device 100 is moving using a GPS receiver.

As a fourth example, the controller 170 can obtain whether the display device 100 is moving based on whether the case 310 is opened or closed.

The movable display device 100 can further include the case 310. The display 180 can be supported by the case 310.

The case 310 can prevent the display 180 from being damaged during the movement of the display device 100.

The display device 100 can be moved while the case 310 is closed. Also, the display device 100 can provide content while the case 310 is open. When the case 310 is closed and then opened, it may be a case where a user moves the display device 100 and then uses the display device 100 again.

Accordingly, the controller 170 can recognize that the position of the display device 100 has moved when the case 310 is closed and then opened. Accordingly, the controller 170 can obtain whether the signal level of the wireless network is less than the preset reference level when the case 310 is closed and then opened.

Meanwhile, regardless of the movement of the display device 100, whether the case 310 is opened or closed may mean the passage of a certain amount of time. For example, if the case 310 is opened, closed, and then opened again, the user may finish watching a video, do something else, and then watch the video again. In this case, there may be a high possibility that a change has occurred in the network environment. Accordingly, the controller 170 may obtain whether the signal level of the wireless network is less than the preset reference level based on whether the case 310 is opened or closed.

In summary, the controller 170 may detect the movement of the display device 100 in various ways and obtain whether the signal level of the wireless network is less than the preset reference level.

If the signal level of the connected wireless network is higher than the preset reference level, the controller 170 can change the access network based on the user's preference or the signal strength of another wireless network S14.

The controller 170 can change the access network based on the user's preference.

The controller 170 can obtain the user's preference based on the preference that the user has pre-entered for each wireless network. Alternatively, the controller 170 can obtain the network designated as the user's preferred network as the network with the highest preference.

The controller 170 can change the access network to the wireless network with the highest user preference.

Alternatively, the controller 170 may change the access network based on the signal strength of another wireless network.

The controller 170 may obtain the signal level of another wireless network. The controller 170 may change the access network to the wireless network having the highest signal level among the other wireless networks. Meanwhile, the controller 170 may not change the access network if the signal level of the wireless network being connected is higher than the signal level of the other wireless network.

Meanwhile, if the signal level of the wireless network to which the display device 100 is connected is higher than the preset reference level, there may be no problem in using the service through the network even if the access network is not changed. Accordingly, according to an embodiment, if the signal level of the wireless network to which the display device 100 is connected is higher than the preset reference level, the controller 170 may maintain the access network. Alternatively, if the signal level of the wireless network to which the display device 100 is connected is higher than the preset reference level, the controller 170 may display a message for obtaining whether to change the access network.

The controller 170 can change the access network based on the preset priority if the signal level of the connected wireless network is lower than the preset reference level S15.

There may be a plurality of wireless networks that the controller 170 can change into the access network. The controller 170 can change the access network to any one of the plurality of wireless networks based on the preset priority.

Regarding the preset priority, it will be described in detail later with reference to FIG. 14.

The controller 170 can receive user input for controlling an external device after changing the access network S17.

The external device may include an electronic device that can be remotely controlled by the display device 100.

The external device may include an electronic device that provides an Internet of Things function. The display device 100 can remotely control an electronic device connected to the same network. The types of electronic devices that can be remotely controlled by the display device 100 may be various, such as lighting, air conditioners, washing machines, and air purifiers.

In addition, the external device may include an electronic device such as a set-top box that provides content services to the display device 100 connected to the same network.

The network to which the external device is connected may be the same as the network before the change of the display device 100. Therefore, when the access network of the display device 100 is changed, the network to which the external device is connected and the network to which the display device 100 is connected may be different.

Accordingly, there may be cases where the display device 100 cannot remotely control the external device.

If the controller 170 cannot control the external device, the controller 170 may display a message requesting to change the wireless network to which the external device is connected S19.

The controller 170 may display a message requesting a change in the network of the external device according to the first embodiment or the second embodiment below based on the type of the changed access network. As the controller 170 displays a message requesting a change in the network, the user can know the cause of the external device not being controlled, and can change the network of the external device to control the external device again.

The type of changed access network may include a network connected through a different AP than before the change and a network connected through the same AP as before the change.

First, the first embodiment will be described.

The first embodiment may be an embodiment in which the type of the changed access network is a network connected through a different AP than before the change.

According to the first embodiment, when the controller 170 receives a user input for selecting an external device connected to the wireless network before the change after changing the access network, the controller 170 may display a message requesting a change of the wireless network connected to the external device.

The controller 170 may change the access network to a network connected through a different AP than before the change. Accordingly, the external device and the display device 100 may each be connected to the network through different APs.

In this case, the display device 100 cannot remotely control the external device.

Therefore, the controller 170 may display a message requesting a change of the network connected to the external device without separately obtaining whether the external device can be controlled.

Next, the second embodiment will be described.

The second embodiment may be an embodiment in which the type of the changed access network is a network connected through the same AP as before the change.

According to the second embodiment, when the controller 170 receives a user input for selecting an external device connected to the wireless network before the change after changing the access network, the controller 170 can obtain whether the external device is controllable.

If the external device is uncontrollable, the controller 170 can display a message requesting a change of the wireless network connected to the external device.

On the other hand, if the external device is controllable, the controller 170 may not display any message.

Compared to the first embodiment, the controller 170 of the second embodiment can further obtain whether the external device is controllable.

If the network of display device 100 is changed to a network that can be accessed through the same AP as before the change, the controllability of each electronic device may differ.

Therefore, the controller 170 can obtain whether or not the external device can be controlled if the network is changed to a network that can be accessed through the same AP as before the change.

If the controller 170 cannot control the external device, the controller 170 can display a message requesting a change of the wireless network to which the external device is connected.

Next, a method for the display device 100 to obtain whether the external device can be controlled is specifically described.

The display device 100 can obtain whether the external device can be controlled based on whether the display device 100 transmits a control signal to the external device and whether the display device 100 receives a response signal from the external device.

The control signal can be a signal transmitted by the display device 100 to remotely control the external device.

If the external device can be controlled according to the control signal, the display device 100 can receive a response signal corresponding to the control signal from the external device.

Meanwhile, if the external device cannot be controlled according to the control signal, the display device 100 does not receive any signal from the external device.

If the controller 170 does not receive a response signal from the external device, the controller 170 can obtain that the external device cannot be controlled. If the controller 170 is found to be unable to control an external device, the controller 170 can display a message requesting a change to the wireless network to which the external device is connected.

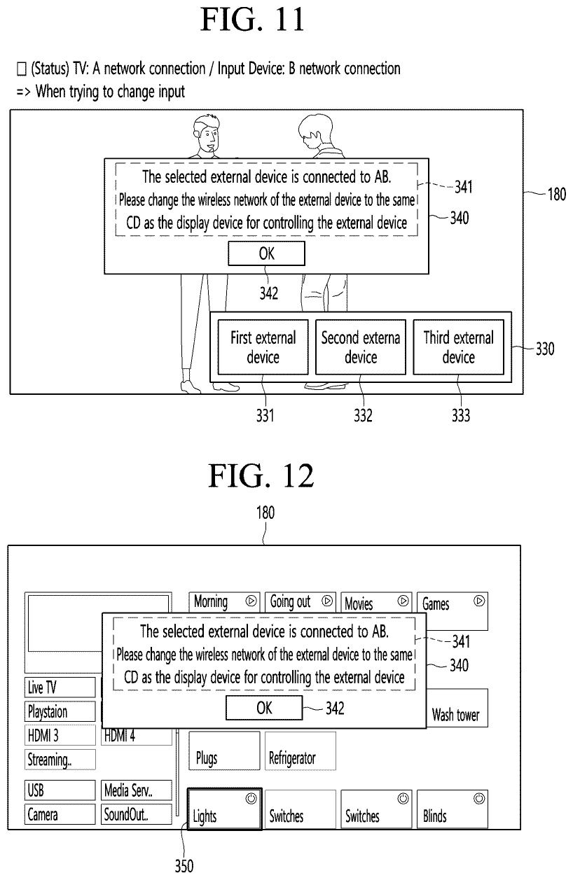

Next, with reference to FIGS. 11 and 12, an example of a message requesting a change in a wireless network connected to an external device is described.

FIG. 11 is an example diagram illustrating a message that requests a change of a wireless network to which an external device is connected, displayed by a display device according to an embodiment of the present disclosure.

FIG. 11 may be a diagram showing an operation after the access network of display device 100 is changed. The network name of the display device 100 before the change may be ‘AB’. And, the network of the display device 100 may have been changed to a network with the network name ‘CD’.

Referring to FIG. 11, an external device list 330 of the display 180 is displayed. The external device list 330 may include an item corresponding to at least one external device. For example, the external device list 330 may include an item 331 corresponding to a first external device, an item 332 corresponding to a second external device, and an item 333 corresponding to a third external device.

The external device list 330 may include an item corresponding to an external device providing content using a network, but is not limited thereto.

The controller 170 may receive a user input for selecting at least one item from the external device list 330. For example, the controller 170 may receive a user input for selecting the item 331 corresponding to the first external device from the external device list 330.

The first external device may be an external device connected to the same network as the network before the change of the display device 100. For example, the network name to which the first external device is connected may be ‘AB’. That is, the first external device may be connected to a network different from the changed access network of the display device 100.

Accordingly, the display device 100 may not be able to control the first external device. Or, the display device 100 may not be able to receive content from the first external device through the network.

When the controller 170 receives a user input for selecting the item 331 corresponding to the first external device, the controller 170 may display a message 341 requesting a change in the wireless network to which the external device is connected.

The message 341 requesting a change in the wireless network may be a message for requesting that the access network of the external device be changed to the same as the access network of the display device 100.

The message 341 requesting a change in the wireless network to which the external device is connected may include, but is not limited to, content such as ‘The selected external device is connected to AB. Please change the wireless network of the external device to the same CD as the display device for controlling the external device.’

The message 340 requesting a change in the wireless network to which the external device is connected may be displayed in the notification window 34. In addition, the notification window 340 may include an ‘OK’ icon 342. The controller 170 can close the notification window 340 upon receiving user input selecting the ‘OK’ icon 342.

FIG. 12 is an example diagram illustrating a message that requests a change of a wireless network to which an external device is connected, displayed by a display device according to an embodiment of the present disclosure.

FIG. 12 may be a drawing showing an operation after the access network of the display device 100 is changed.

Referring to FIG. 12, a main menu of a smart home application is displayed on the display 180. The main menu of the smart home application may include items corresponding to various external devices that provide content to the display device 100 or various external devices that can be remotely controlled via the display device 100.

The controller 170 may receive a user input for selecting at least one item from the main menu of the smart home application. For example, the controller 170 may select an item 350 corresponding to lighting from the main menu of the smart home application.

The light may be an external device connected to the same network as the network before the change of the display device 100. For example, the network name to which the light is connected may be ‘AB’. In other words, the light may be connected to a network different from the changed access network of the display device 100. Accordingly, the display device 100 may not be able to control the light.

When the controller 170 receives a user input for selecting the item 350 corresponding to the light, the controller 170 may display a message 341 requesting a change of the wireless network to which the light is connected.

A specific description related to the message 341 requesting a change of the wireless network to which the light is connected is the same as that described with respect to the message 341 requesting a change of the wireless network in FIG. 11.

In summary of FIG. 8, the display device 100 according to one embodiment of the present disclosure can change the access network based on the signal level of the wireless network to which it is connected.

Accordingly, even when the network environment changes due to the movement of the location of the display device 100, etc., the display device 100 can automatically connect to the optimal network. Accordingly, there is a convenience advantage in that the user does not need to directly change the network.

Next, a method for changing an access network by a display device 100 according to an embodiment of the present disclosure is described.

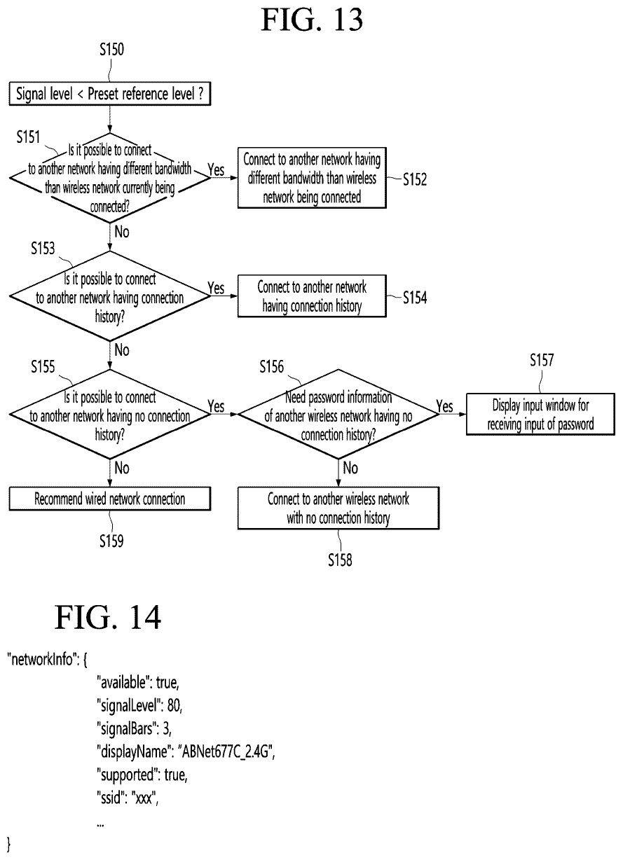

FIG. 13 is a flowchart for explaining a method for changing an access network by a display device according to an embodiment of the present disclosure.

FIG. 13 is a flowchart that embodies S15 of FIG. 8.

If the signal level of a wireless network being connected is lower than a preset reference level, the controller 170 can change the access network according to a preset priority S150.

According to an embodiment, the controller 170 obtains whether to change the access network, and if the controller 170 obtains that changing the access network, the controller 170 can change the access network according to a preset priority.

The controller 170 can obtain whether the controller 170 is possible to connect to another network that has only a different bandwidth from the currently connected wireless network S151.

The network that has only a different bandwidth may be a network that can be connected through the same AP as the network before the change.

The AP may include a dual band AP. The dual band AP may generate two network signals having different frequency bands. For example, the dual band AP may generate a network signal having a bandwidth of 2.4G and a network signal having a bandwidth of 5G.

In relation to this, it will be described with reference to FIG. 14.

FIG. 14 is an example of wireless network information acquired by a display device according to an embodiment of the present disclosure.

The display device 100 of FIG. 14 may be connected to a network having a different bandwidth from the network to which the display device 100 of FIG. 10 is connected.

That is, the display device 100 of FIG. 14 and the display device 100 of FIG. 10 may be connected to different networks through the same AP.

The name of the network to which the display device 100 of FIG. 14 is connected may be ‘ABNet677C_2.4G’. On the other hand, the name of the network to which the display device 100 of FIG. 10 is connected may be ‘ABNet677C_5G’.

‘ABNet677C_2.4G’ may be a network name having a bandwidth of 2.4G. In addition, ‘ABNet677C_5G’ may be a network name having a bandwidth of 5G.

In addition, networks that can be accessed through one AP may have names that include the same keyword. ‘ABNet677C_2.4G’ and ‘ABNet677C_5G’ may include ‘ABNet677C’ as a keyword.

Therefore, a network that has a different bandwidth from the wireless network being accessed may have a name that includes the same keyword as the name of the wireless network being accessed.

That is, the controller 170 may obtain whether the controller 170 is accessible to another wireless network that has a name that includes the same keyword as the name of the wireless network being accessed.

Again, FIG. 13 is described.

If the controller 170 acquires that the controller 170 can connect to another network that has a different bandwidth from the connected wireless network, it can connect to a network that has a different bandwidth from the connected wireless network S153.

That is, the controller 170 can change the access network by acquiring another wireless network that has a different bandwidth from the connected wireless network as the first priority.

Alternatively, the controller 170 can change the access network by acquiring another wireless network that has a name that includes the same keyword as the name of the connected wireless network as the first priority.

As described above, another network with different bandwidths may be accessible through the same AP as before the change.

The AP before the network change may be the AP that the user mainly uses. Accordingly, the settings related to the AP may be optimized for the user.

In addition, when changing the network of display device 100 to a network that can be accessed through the same AP, the external device connected to the network before the change can be controlled depending on the type of the external device.

Therefore, the controller 170 can change the access network by acquiring another network with a different bandwidth than the wireless network being connected as the first priority.

Alternatively, the controller 170 can change the access network by acquiring another wireless network with a name that includes the same keyword as the name of the wireless network being connected as the first priority.

If the controller 170 obtains that it is not possible to connect to another network with a different bandwidth than the wireless network it is connected to, the controller 170 can obtain whether it is possible to connect to another wireless network with a connection history S153.

If the controller 170 obtains that it is possible to connect to another wireless network with a connection history, the controller 170 can connect to another wireless network with the connection history S154.

The wireless network with the connection history may be a network that the user directly selected as an access network. In other words, the wireless network with the connection history may be a network preferred by the user.

In addition, the wireless network with the connection history may be a network in which password information for connecting to the network is pre-stored. The password information may include wireless network information and a password corresponding to the wireless network. Therefore, the controller 170 can connect to the network without going through a step of receiving a password from the user.

Therefore, the controller 170 can change the access network by acquiring another wireless network with the connection history as the second priority.

If the controller 170 obtains that it is not possible to connect to another wireless network with the connection history, the controller 170 can obtain whether it is possible to connect to another wireless network without the connection history S155.

If the controller 170 obtains that it is possible to connect to another wireless network without the connection history, the controller 170 can obtain whether password information of another wireless network without the connection history is required S156.

Meanwhile, if the controller 170 obtains that password information of another wireless network without the connection history is required, the controller 170 can display an input window for entering a password S157.

For example, the controller 170 can display a deep link for entering the password. The deep link can be a URL (Uniform Resource Locator) link that connects to a specific page of an application.

The controller 170 can display a deep link that connects to a password entry page of a network-related application for receiving the password.

However, the controller 170 displaying a deep link is only an example, and the method for receiving the password can vary.

Meanwhile, if the controller 170 obtains that password information of another wireless network without the connection history is not required, the controller 170 can immediately connect to another wireless network without the connection history S158.

The network without the connection history may be a network that the user does not prefer compared to a network with the connection history.

In addition, password information may be required to access a wireless network without the connection history. A wireless network without the connection history may be a network in which the password information is not stored. Therefore, the controller 170 may access the network after going through a step of receiving a password from the user.

Therefore, the controller 170 may change the access network by acquiring another wireless network without the connection history as the third priority.

According to an embodiment, the controller 170 may acquire another wireless network in which password information is stored as the second priority, and acquire another wireless network in which password information is not stored as the third priority to change the access network.

That is, the controller 170 may acquire a wireless network that can be accessed without entering a password as a higher priority than a wireless network that requires password entry.

According to an embodiment, the controller 170 can obtain whether the access network has changed.

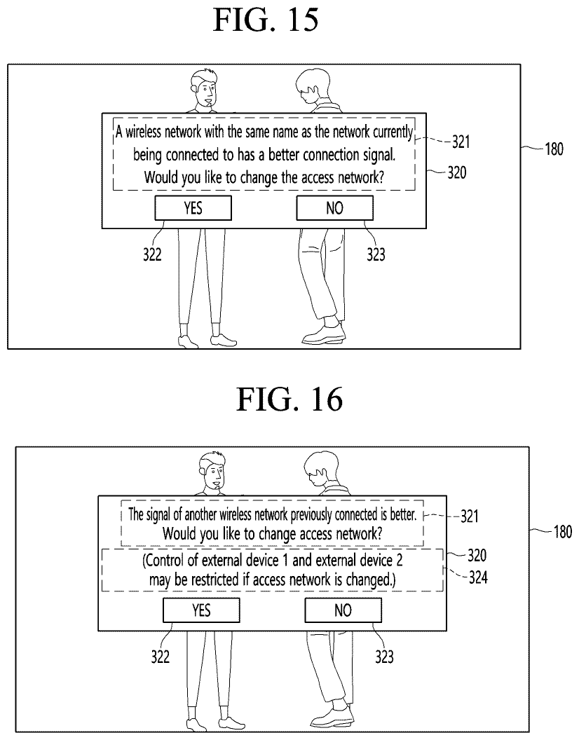

In relation to this, it is described with reference to FIGS. 15 to 17.

FIG. 15 is an example diagram illustrating a message displayed by a display device according to an embodiment of the present disclosure to obtain whether to change an access network to a wireless network having a first priority.

Referring to FIG. 15, the controller 170 may display a message 321 for obtaining whether to change a network. The message 321 for obtaining whether to change a network may include, but is not limited to, content such as ‘A wireless network with the same name as the network currently being connected to has a better connection signal. Would you like to change the access network?’.

The message 321 for obtaining whether to change a network may be displayed within a notification window 320. In addition, the notification window 320 may include a ‘YES’ icon 322 and a ‘NO’ icon 323.

When the controller 170 receives a user input selecting the ‘YES’ icon 322, the controller 170 may change the access network to a wireless network having a first priority. On the other hand, the controller 170 may not change the access network if the controller 170 receives user input selecting the ‘NO’ icon 323.

Accordingly, the access network may not be changed when the user does not intend to do so.

FIG. 16 is an example diagram illustrating a message displayed by a display device according to an embodiment of the present disclosure to obtain whether to change an access network to a wireless network having a second priority.

Referring to FIG. 16, the controller 170 may display a message 321 for obtaining whether to change a network. The message 321 for obtaining whether to change a network may include, but is not limited to, content such as ‘The signal of another wireless network previously connected is better. Would you like to change access network?’.

Meanwhile, when the controller 170 displays the message 321 for obtaining whether to change a network, the controller 170 may also display a message 324 for notifying that an external device cannot be controlled if the access network is changed.

The message 324 for notifying that an external device cannot be controlled if the access network is changed may include, but is not limited to, content such as ‘Control of external device 1 and external device 2 may be restricted if access network is changed.’

Since the controller 170 displays the message 324 indicating that external devices cannot be controlled when changing the access network, the user can decide whether to change the access network by considering whether external devices can be controlled.

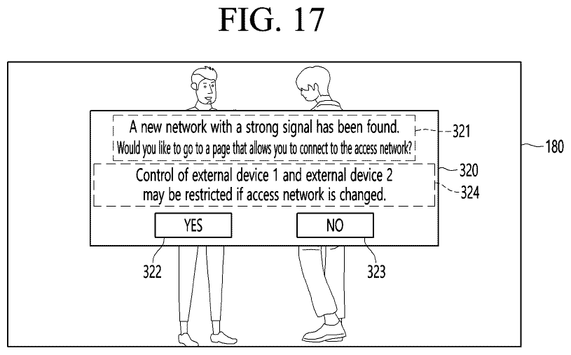

FIG. 17 is an example diagram illustrating a message displayed by a display device according to an embodiment of the present disclosure to obtain whether to change an access network to a wireless network having a third priority.

Referring to FIG. 17, the controller 170 may display a message 321 for obtaining whether to change a network. The message 321 for obtaining whether to change a network may include, but is not limited to, content such as ‘The signal of another wireless network previously connected is better. Would you like to change access network’.

Meanwhile, when the controller 170 displays the message 321 for obtaining whether to change a network, the controller 170 may also display a message 324 for notifying that an external device cannot be controlled if the access network is changed.

The message 324 for notifying that an external device cannot be controlled if the access network is changed may include, but is not limited to, content such as ‘A new network with a strong signal has been found. Would you like to go to a page that allows you to connect to the access network?’.

Since the controller 170 displays message 324 indicating that external devices cannot be controlled when changing the access network, the user can decide whether to change the access network by considering whether external devices can be controlled.

Meanwhile, according to an embodiment, the display device 100 according to the embodiment of FIG. 15 may also display the message 324 indicating that the external device cannot be controlled when the access network is changed.

According to the embodiment of FIGS. 15 to 17, the display device 100 may not change the access network regardless of the user's intention by obtaining whether the access network is changed.

In addition, according to the embodiment of FIGS. 15 to 17, the display device 100 may display a message 324 indicating that the external device cannot be controlled if the access network is changed, thereby allowing the user to decide whether to change the access network by considering whether the external device can be controlled.

Meanwhile, the display device 100 of the present disclosure may include a mobile terminal 500. The mobile terminal 500 may display a message 560 for obtaining whether a network is changed on the display 551.

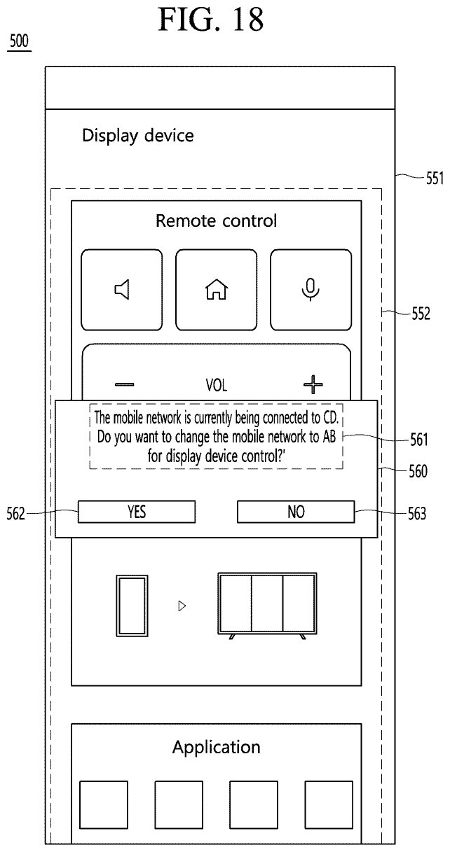

With respect to an embodiment in which a message requesting a change of a wireless network is displayed on a mobile terminal, a description is given with reference to FIG. 18.

FIG. 18 an example diagram illustrating a message displayed on a display of a mobile terminal controlling a display device according to an embodiment of the present disclosure.

FIG. 18 is a drawing illustrating a scene in which the mobile terminal 500 displays a menu 552 for controlling the display device 100. The menu 552 for controlling the display device 100 may include, but is not limited to, remote control items, sharing items, application items, etc.

The mobile terminal 500 can control the display device 100 by connecting to the same wireless network as the display device 100.

However, the access network of the display device 100 may have changed at the time when the mobile terminal 500 displays the menu 552 for controlling the display device 100. Accordingly, the access networks of the mobile terminal 500 and the display device 100 may be different. For example, the mobile terminal 500 may be connected to CD, and the display device 100 may be connected to AB.

If the access networks of the mobile terminal 500 and the display device 100 are different, the mobile terminal 500 may not be able to remotely control the display device 100.

Accordingly, when the mobile terminal 500 receives a user input for selecting one of the items included in the menu 552 for controlling the display device 100, the mobile terminal 500 can obtain whether the access network of the mobile terminal 500 is changed.

Specifically, the mobile terminal 500 can display a message 561 for obtaining whether the access network is changed.

The message 561 for obtaining whether the access network is changed may include, but is not limited to, content such as ‘The mobile network is currently connected to CD. Do you want to change the mobile network to AB for display device control?’

The message 561 for obtaining whether the access network is changed may be included in the notification window 560. The notification window 560 may include a ‘YES’ icon 562 and a ‘NO’ icon 563. When the controller 170 receives a user input selecting the ‘YES’ icon 563, the access network of the mobile terminal 500 may be changed to AB, which is the same as the access network of the display device 100. On the other hand, when the controller 170 receives a user input selecting the ‘NO’ icon 563, the state of being connected to the CD may be maintained.

Again, FIG. 13 is described.

If the controller 170 obtains that it is impossible to connect to another wireless network without the connection history, it can recommend a wired network connection S159.

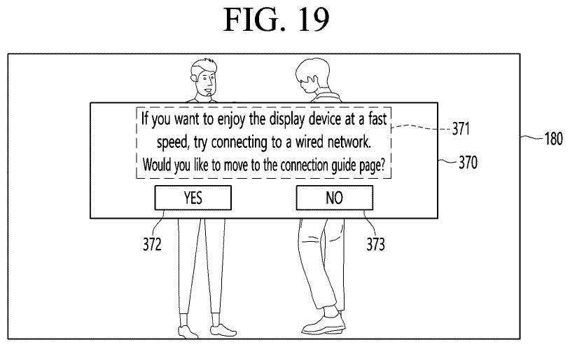

In this regard, it will be described with reference to FIG. 19.

FIG. 19 is an example diagram illustrating a message displayed by a display device according to an embodiment of the present disclosure to recommend a wired network connection.

If the controller 170 cannot change to another wireless network being connected, it can display a message 371 for recommending a wired network connection.

If the controller 170 cannot connect to all of the wireless networks acquired with the first priority, the second priority, and the third priority, it can display a message 371 for recommending a wired network connection.

The message 371 for recommending a wired network connection may include, but is not limited to, content such as ‘If you want to enjoy the display device at a fast speed, try connecting to a wired network. Would you like to move to the connection guide page?’

The message 370 for recommending a wired network connection may be included in a notification window 370. The notification window 370 may include a ‘YES’ icon 372 and a ‘NO’ icon 373. When the controller 170 receives a user input for selecting the ‘YES’ icon 372, the controller 170 may move to a page for guiding the wired connection method. When the controller 170 receives a user input for selecting the ‘NO’ icon 373, the controller 170 may close the notification window 370.

In summary of FIG. 13, the display device 100 according to one embodiment of the present disclosure may change the network being connected according to a preset priority.

Accordingly, the display device 100 can automatically maintain a state of being connected to the most suitable wireless network.

Accordingly, there is an advantage of minimizing the inconvenience of users having to directly connect to the wireless network.

According to an embodiment of the present disclosure, the above-described method may be implemented with codes readable by a processor on a medium in which a program is recorded. Examples of the medium readable by the processor include a ROM (Read Only Memory), a Random Access Memory (RAM), a CD-ROM, a magnetic tape, a floppy disk, an optical data storage device, and the like.

The display device as described above is not limited to the configuration and method of the above-described embodiments, but the embodiments may be configured by selectively combining all or part of each embodiment such that various modifications can be made.

1. A display device, comprising:
a case;
a display supported by the case;
a network interface connected to a wireless network; and
a controller configured to change an access network based on movement of a position of the display device or whether the case is opened or closed.

2. The display device of claim 1, wherein the controller is configured to change the access network according to a preset priority when a signal level of a connected wireless network is below a preset reference level.

3. The display device of claim 2, wherein the controller is configured to change the access network by acquiring another wireless network with a different bandwidth than a currently connected wireless network as a first priority.

4. The display device of claim 2, wherein the controller is configured to change the access network by acquiring another wireless network having a name including the same keyword as a name of a currently connected wireless network as a first priority.

5. The display device of claim 3, wherein the controller is configured to change the access network by acquiring another wireless network with a connection history as a second priority and another wireless network with no connection history as a third priority.

6. The display device of claim 3, wherein the controller is configured to change the access network by acquiring another wireless network in which password information is stored as a second priority and another wireless network in which password information is not stored as a third priority.

7. The display device of claim 1, wherein the controller is configured to display a message recommending a wired network connection if a currently connected wireless network cannot be changed to another wireless network.

8. The display device of claim 1, wherein the controller is configured to, when acquiring whether the access network has been changed or not, display a message notifying that an external device connected to the access network cannot be controlled if the access network is changed.

9. The display device of claim 1, wherein the controller is configured to, after changing the access network, when receiving a user input for selecting an external device connected to a wireless network before the changing, display a message requesting a change of the wireless network connected to the external device.

10. The display device of claim 9, wherein the controller is configured to, when receiving the user input, transmit a control signal to the external device to determine whether control is possible, and if the external device cannot be controlled, display the message requesting the change of the wireless network connected to the external device.

11. The display device of claim 1, wherein the controller is configured to change the access network based on a user's preference or a signal level of another wireless network when a signal level of the access network is higher than a preset reference level.

12. An operating method of a display device comprising a case and a display supported by the case, the method comprising:
connecting to a wireless network; and
changing an access network,
wherein changing the access network comprises:
changing an access network based on movement of a position of the display device or whether the case is opened or closed.

13. The operating method of claim 12, wherein the changing the access network comprises:
changing the access network according to a preset priority when a signal level of a connected wireless network is below a preset reference level.

14. The operating method of claim 13, wherein changing the access network according to the preset priority comprises:
changing the access network by acquiring another wireless network with a different bandwidth than a currently connected wireless network as a first priority.

15. The operating method of claim 13, wherein the changing the access network comprises:
changing the access network by acquiring another wireless network having a name including the same keyword as a name of a currently connected wireless network as a first priority.

16. The operating method of claim 14, wherein the changing the access network according to the preset priority further comprises:
changing the access network by acquiring another wireless network with a connection history as a second priority and another wireless network with no connection history as a third priority.

17. The operating method of claim 14, wherein the changing the access network according to the preset priority further comprises:
changing the access network by acquiring another wireless network in which password information is stored as a second priority and another wireless network in which password information is not stored as a third priority.

18. The operating method of claim 12, further comprising:
displaying a message recommending a wired network connection if a currently connected wireless network cannot be changed to another wireless network.

19. The operating method of claim 12, further comprising:
when acquiring whether the access network has been changed or not, displaying a message notifying that an external device connected to the access network cannot be controlled if the access network is changed.

20. The operating method of claim 12, further comprising:
after changing the access network, when receiving a user input for selecting an external device connected to a wireless network before the changing, displaying a message requesting a change of the wireless network connected to the external device.
